(19) United States
(12) Patent Application Publication
(10) Pub. No.: US 2002/0096799 A1
(43) Pub. Date: Jul. 25, 2002

(54) Method for manufacturing the ball joint for vehicles

(76) Inventors: Sung Hwan Kim, Changwon (KR); Young-Jin Kim, Changwon (KR); Young-Su Kim, Jinhae (KR); Ki-Yong Sung, Changwon (KR); Young-Soo Kim, Busan (KR)

Correspondence Address: JACOBSON HOLMAN PLLC, 400 SEVENTH STREET N.W., SUITE 600, WASHINGTON, DC, 20004, US

(21) Appl. No.: 09/827,171

(22) Filed: Apr. 6, 2001

(30) Foreign Application Priority Data
Jan. 22, 2001 (KR) 2001-3541

(51) Int. Cl. B29C 70/68; B29C 45/14

(52) U.S. Cl. 264/242; 264/265

(57) ABSTRACT

The present invention's method for manufacturing the ball joint for automobile, consisting of a housing 2 connected to the end of rod 3, a round head 1a, a neck 1c and a screwed part 1b, which has a build-in ball stud 1 designed for the said round head 1a to go around the said housing, is composed of coating the said round head 1a of the ball stud 1 with a lubricant, moulding the housing 2 with the FRP (Fiber Reinforced Plastics), and then insert-moulding the round head 1a of the said ball stud 1 into the housing 2.

Accordingly, this invention is designed to insertion-mould the ball stud into the said housing even when the rod and housing are moulded with the fiber reinforced plastics and, therefore, it is possible to eliminate a process which is required to forcedly insert the ball stud into the said housing, to easily prevent the inside between the ball stud and housing from being loose even when both of the metal and plastic materials are combined for production, and to improve the housing strength resulting to its longer service life.

### BACKGROUND OF THE INVENTION

This invention relates to the method for manufacturing the ball joint to be used for the joint part of a steering apparatus or suspension system of any vehicles, in more detail, which relates to the manufacturing method of the vehicle's ball joint designed to easily prevent the inside between the ball stud and housing from being loose even when the plastic and metal materials are mixed with each other and manufactured.

In general, the ball joint is designed to go around and be inclined on a certain level, is used for the steering apparatus and suspension system of vehicles, and is mainly classified into the metal-made ball joint and the mixed plastic & metal-made ball joint.

The above metal-made ball joint is designed for the ball stud's round head to be inserted into the inside of ball seat to be available for rotation and inclination, for the said ball seat connected to the ball stud to be attached to the housing, and for its dust cover to prevent any foreign substance from coming into the inside of the housing.

Thus, this applicant registered a patent for the improved metal-made ball joint with Korean Patent Office (No. 272084) after improving Japan Public Patent No. Pyung1-172610 and U.S. Pat. No. 5,001,321.

The improved ball joint has a dust cover, preventing dust or foreign matter from coming into the inside between the ball stud's round head and ball seat, which is attached by a lip to a fastening slot formed in one external end of the ball seat, where a cap is installed in a ring-shaped keeper extended and cut in the length direction of the other end of the ball seat, a number of prominent places are projected within the housing with a circular section in the diameter direction to be aligned in the direction of length, and a hollowed part is formed in the external lower side of the said ring-shaped keeper.

However, the said metal-made ball joint must have so many components, such as a ball stud, ball seat, housing, dust cover, and rod connected to the housing, that its assembly processes can become very complicated and disadvantageous.

To reduce the number of such components and assembly processes, therefore, the ball joint was invented by means of the mixed plastic and metal materials, and its manufacturing method consists of moulding a set of housing to both the ends of rod and then forcedly inserting the round head of the ball stud into the housing.

The ball joint manufactured in such way is designed for the metal ring to be installed within the opening of the housing, in order4 to prevent the ball stud from being removed.

Because the existing manufacturing method of the ball joint has been designed for the ball stud to be forcedly inserted and installed into the housing, however, the housing may be easily broken when its material is not strong enough to bear the force, and the ball stud inserted into the housing may be also removed so easily.

Since the ball stud inserted into the ball stud may be easily removed, also, a metal ring, as a separate means, is required to strengthen the opening of the housing, eventually, which should result in the increased number of components and processes.

In particular, because it has been difficult to strengthen the material quality of the housing the insufficient housing strength shortens the service life of the ball stud product even when a separate component is used to prevent the ball stud from being removed.

Accordingly, the purpose of the present invention designed to solve such existing technical problems as stated above is to eliminate the process of the ball stud's forced-insertion into the housing, to easily prevent the inside between the ball stud and housing from being loose even when both of the metal and plastic materials are combined for production, and to improve the housing strength resulting to its longer service life.

To achieve the above stated purposes, this invention's manufacturing method of the ball joint for vehicles, consisting of a plastic housing connected to the end of rod, the said round head, the neck and the screwed part, which has the build-in ball stud designed for the said round head to go around the said housing, is composed of coating the said round head of the ball stud with a lubricant, moulding the housing with the fiber reinforced plastics, and then insert-moulding the round head of the said ball stud into the housing.

### BRIEF DESCRIPTION OF THE DRAWINGS

FIG. 1 is an oblique view of the present invention's ball joint for vehicles.

FIG. 2 is an oblique view of this invention's ball stud of the ball joint for vehicles.

FIG. 3 is a flow-chart showing the present invention's manufacturing method of the ball joint for vehicles.

FIG. 4 is a cross-sectional view indicating another example of this invention's ball joint for vehicles.

FIG. 5 is a flow-chart which shows the method for manufacturing the ball joint for vehicles in FIG. 4.

### DETAILED DESCRIPTION OF THE PREFERRED EMBODIMENTS

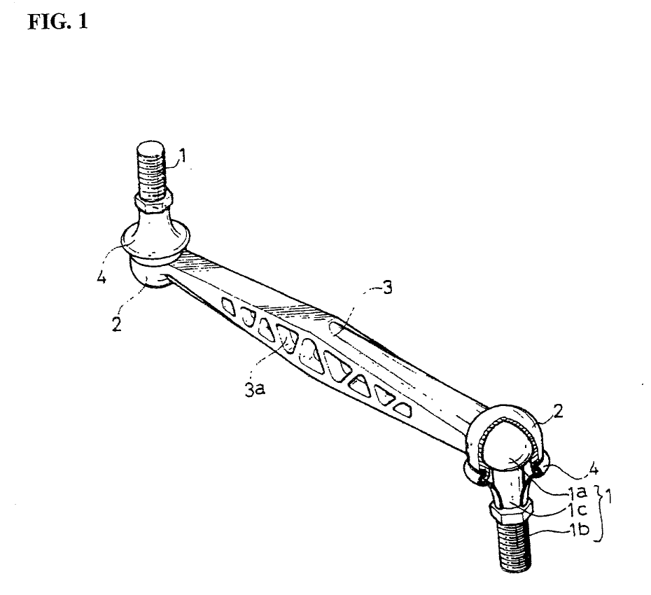

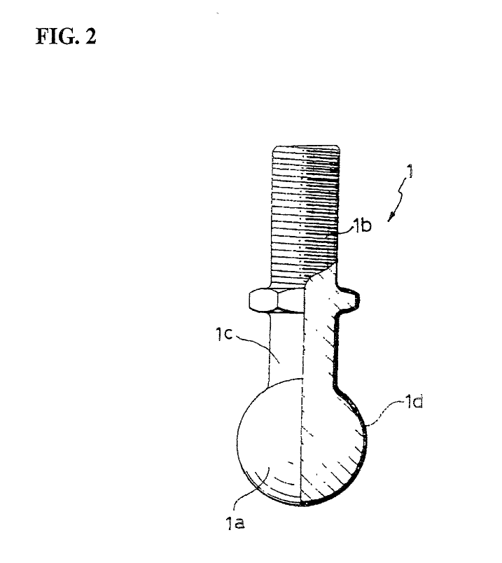

FIGS. 1 and 2 are the drawings showing this invention's ball joint for vehicles, where the said ball joint has such structure as inserting the round head 1a of the ball stud 1 into the inside of the housing 2 to go around and be inclined and setting the said housing 2 to both ends of the rod 3 in an integrated manner.

The working example shows that the dust cover 4 designed to prevent any foreign substance from coming into the inside between the round head 1a of the ball stud 1 and the housing 2 is installed in the surrounding face of the said housing 2, being made of a general rubber material which is changeable with the rotating and inclining motions of the ball stud 1.

The said ball stud 1 consists of the round head 1a with an end extended in a globular shape, the screwed part 1b to be connected to the vehicle's other parts, and the neck 1c to be connected to the said round head 1a and the screwed part 1b, all of which form an complete set.

The above housing 2 has a round form of internal side conforming with the round head 1a of the said ball stud 1, being completely installed in both ends of the rod 3 made of plastics.

In this working example, the said rod 3 has a larger front cross section in the center of length and several slots 3a in both sides for the purpose of saving materials.

This invention's ball joint for vehicles is manufactured in such ways as coating the round head 1a of the said ball stud 1 with a lubricant to form a coated part, moulding the said rod 3 and housing 2 with the fiber reinforced plastics, and then insertion-moulding the round head 1a of the above ball stud 1 into the housing 2.

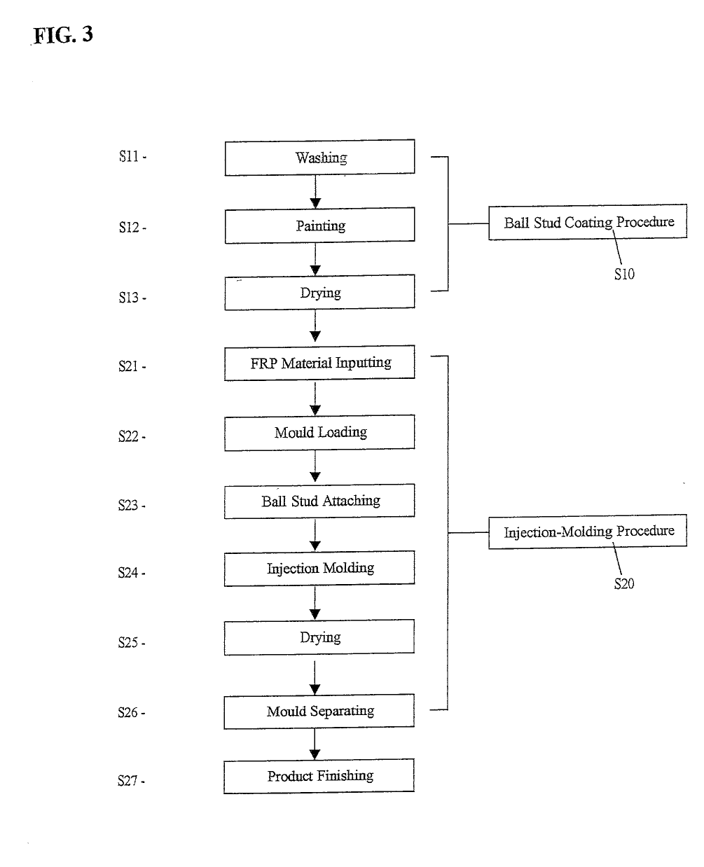

This manufacturing method of the ball joint for vehicles is specified in more detail, referring to FIG. 3.

The present invention's method for manufacturing the ball joint for vehicles consists of a coating procedure S10 of the ball stud and a moulding procedure S20 to insertion-mould the ball stud 1.

The coating procedure S10 of the above ball stud 1 includes a washing step S11 to wash the said ball stud 1, a painting step S12 to paint the round head 1a of the said ball stud with a lubricant, and a drying step to dry the ball stud painted with the lubricant 1 and finish the coating part 1d.

Then, both of the solid and liquid lubricants are available for the above use, and the solid lubricant is recommended for better use.

The said moulding procedure S20, intended to insertion-mould the ball stud 1 into the housing 2 when injection-moulding a complete set of the housing 2 and rod 3, is to input the fiber reinforced plastics into an injection-moulding machine (Mitoshi), above all, in order to mould the housing 2 and rod 3 with the fiber reinforced plastics (S21).

At the time when inputting the materials into the injection-moulding machine as specified above, the mould (Mitoshi) is loaded on the injection-moulding machine to mould the housing 2 and rod 3 (S22).

After the round head 1a of the ball stud 1 is set to the housing of the mould just before injection-moulding the housing 2 and rod 3 by means of the injection-moulding machine (S23), then, the injection-moulded housing 2 and rod 3 are cooled within the mould (S24) and then separated from the mould (S25).

The ball joint separated from the mould, as stated above, becomes the product under the condition that the ball stud 1 is attached to the housing 2 (S26).

The above method for manufacturing the ball joint for vehicles makes it possible for the ball stud to be driven while the ball stud 1's round head 1d is in contact with the inside of the housing 2 and, therefore, to prevent the ball stud 1 from being loose, and for the housing 2 to easily support the ball stud 1 even during the driving and inclining motion of the ball stud 1.

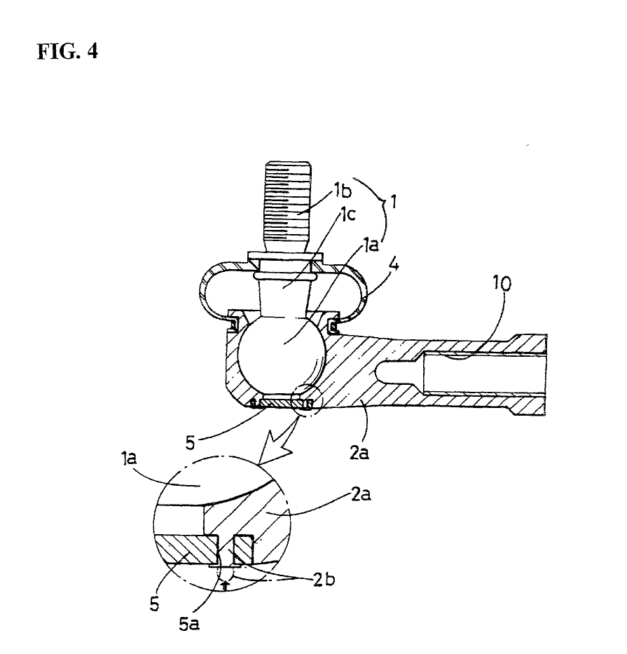

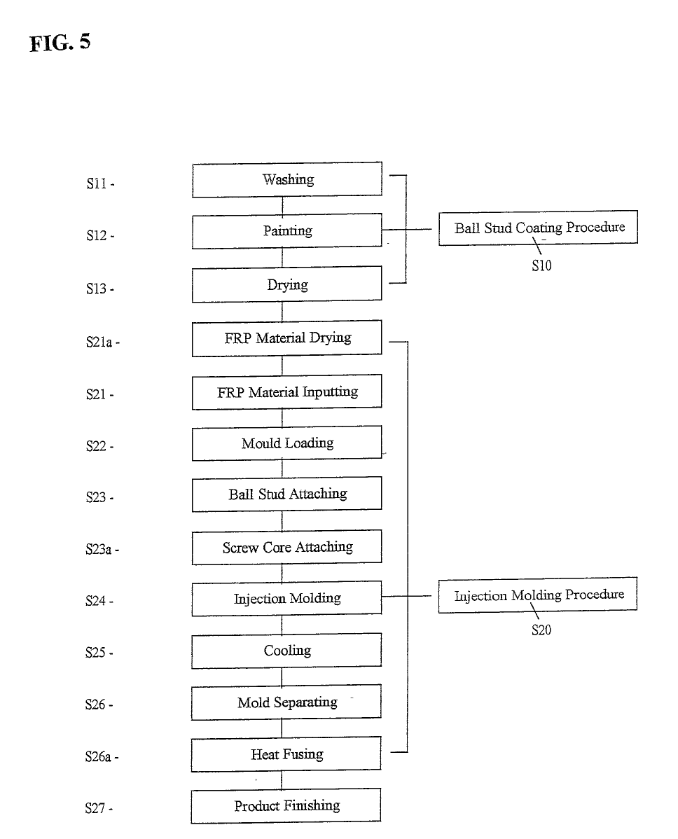

As shown in FIGS. 4 and 5, on the other hand, the present inventidn's ball joint for vehicles has the ball stud 1's round head 1a which is not completely globe-shaped, and the separate rod and housing which is attached to both ends of the rod. For this reason, the hole is formed in the lower side of the housing 2a separately prepared for the said ball stud 1 to be smoothly driven, and then the hole is closed with the cover 5.

The said ball joint is designed to have a number of fusing points 2b in the edge around the hole in the lower side of the housing 2a, to insert the said fusing points 2b into many inserting holes in the said cover 5, to heat-fuse the end of the said fusing points 2b and the inserting holes 5a of the cover 5, and to build the screw core 10 in the jointing part of the housing 2a connected to the rod.

As specified in the working example, namely, it consists of the coating procedure S10 of the ball stud 1, and the moulding procedure S20 to insertion-mould the ball stud 1 for the injection moulding. The said ball stud 1's coating procedure S10 was already described earlier and so not explained again.

The above moulding procedure S20 is to insertion-mould the ball stud 1 into the housing 2a when injection-moulding the separately formed housing 2a, and consists of firstly drying the fiber reinforced plastics to mould the housing 2a (S21a), inputting the fiber reinforced plastics to the injection-moulding machine (Mitoshi)(S21), loading the mould (Mitoshi) for the housing 2a to the injection-moulding machine S22, setting the round head 1a of the ball stud 1 to the housing section of the mould just before the housing 2a is injected & moulded by the injection-moulding machine (S23), and attaching the screw core 10 to the jointing part of the housing 2a.

Also, the housing 2a is injection-moulded and cooled within the mould (S24), and the mould is separated (S25). After the mould is separated (S26), the fusing points 2b being in conformity with the hole 5a of the cover 5 are inserted and heat-fused (S26a), and then the product becomes finished (S27).

As shown in the working example, this manufacturing method of the ball joint is designed to feed the grease to the hole in the lower part of the housing 2a and close the hole with the cover, for the ball stud 1 to be easily driven while the round head 1d of the ball stud 1 is in contact with the inside of the housing 2, and for the housing 2 to conveniently support the ball stud 1 even during the ball stud 1's driving and inclining motion.

As stated above, the ball stud is insertion-moulded to the said housing to be available for driving when the housing is moulded with the fiber reinforced plastics. For this reason, it is possible and advantageous to eliminate the process of forcedly inserting the ball stud into the housing, to prevent the inside between ball stud and housing from being loose even when both the plastic and metal materials are mixed with each other and manufactured, and to make the service life of the product longer by improving the strength of the housing.

What is claimed is:

1. Manufacturing method of the ball joint for vehicles, consisting of coating the round head of the said ball stud with the lubricant and insertion-moulding the round head of the ball stud into the housing when the housing is moulded with the fiber reinforced plastics, which includes the ball stud consisting of a complete set of or an assembly type of plastics-made housing, the round head, the neck part, the screwed part In both ends of the rod, and ball joint for vehicles designed for the built-in round head of the said ball stud to be driven within the housing.

2. The manufacturing method of claim 1,
wherein the said manufacturing method of the ball joint for vehicles consists of washing out the said ball stud, coating the round head of the said ball stud with the lubricant, and then drying the ball stud coated with the lubricant.
